(19) United States
(12) Patent Application Publication
(10) Pub. No.: US 2025/0263139 A1
(43) Pub. Date: Aug. 21, 2025

(54) SPROCKET DAMPING ASSEMBLY FOR A TRACK-TYPE MACHINE

(71) Applicant: Caterpillar Inc., Peoria, IL (US)

(72) Inventors: Sierra SCHELLPFEFFER, Morton, IL (US); Jonathan D. ZIEGENMEYER, East Peoria, IL (US); Peter M. ZUEHLS, Washington, IL (US); Kyle J. STEFFEN, Congerville, IL (US); Brad S. SALISBURY, Metamora, IL (US)

(73) Assignee: Caterpillar Inc., Peoria, IL (US)

(21) Appl. No.: 18/444,656

(22) Filed: Feb. 17, 2024

(51) Int. Cl. B62D 55/096; B62D 55/125; B62D 55/32

(52) U.S. Cl. CPC B62D 55/0963; B62D 55/125; B62D 55/32

(57) ABSTRACT

A sprocket damping assembly may include at least one arc-shaped damping pad with a plurality of through holes, at least one arc-shaped backing plate with a plurality of through holes, and a plurality of tubular spacers, each including a central through hole. The sprocket damping assembly includes an assembled configuration, where a portion of the tubular spacers is located on one side of the at least one arc-shaped damping pad and the at least one arc-shaped backing plate is located on an opposite side of the at least one arc-shaped damping pad. An axial length of the tubular spacers may align the at least one arc-shaped damping pad with an edge of the drive sprocket, adjacent to teeth of the drive sprocket. The at least one arc-shaped damping pad may be formed of an elastomeric material.

### TECHNICAL FIELD

The present disclosure relates generally to a track drive assembly and continuous ground-engaging track for a mobile industrial vehicle and, more particularly, to a sprocket damping assembly mounted to the side of a drive sprocket for the ground-engaging track.

### BACKGROUND

Mobile industrial machines, such as track-type tractors, are used in a variety of applications and offer the advantage of a rugged build and good performance in challenging ground conditions on a work site. An undercarriage of a common track-type industrial machine may include an endless track made of a number of connected links, a drive sprocket driven by a power source of the industrial machine (e.g., an internal combustion engine or electric motor) that meshes with the links to drive the track, and a number of idler wheels and rollers that distribute the weight of the work machine along the track.

Track-type industrial machines may generate loud noises during operation, which may be objectionable when operating in highly populated areas. Environmental regulations, both in the United States and in other countries, are increasingly being directed to suppress noises generated by the operation of construction equipment. One potential source of operating noise that can also be a source of wear on the industrial machine is the metal-to-metal impact occurring between the teeth of the drive sprocket and the bushings of the track links during the meshing between the teeth and the links.

A sprocket damping assembly for a sprocket wheel is described in U.S. Pat. No. 11,535,319 B2, issued Dec. 27, 2022 (“the '319 Patent”). The sprocket damping system described in the '319 Patent includes a damping ring that is disposed on the sprocket wheel, the damping ring including an integrally formed retention groove for retaining a retention device. While the sprocket damping assembly described in the '319 Patent may be helpful in some circumstances, the sprocket damping assembly may be incompatible with certain sprocket designs, and the sprocket damping assembly may be improved.

Aspects of the present disclosure may solve one or more of the problems set forth above and/or other problems in the art. The scope of the current disclosure, however, is defined by the attached claims, and not by the ability to solve any specific problem.

### SUMMARY

In one aspect, a damping assembly for a drive sprocket of a mobile industrial machine including at least one arc-shaped damping pad that includes a radially outer surface; a radially inner surface; a planar inner surface extending between the radially outer surface and the radially inner surface; a planar outer surface extending between the radially outer surface and the radially inner surface. The at least one arc-shaped damping pad further includes a plurality of through holes extending through the at least one arc-shaped damping pad from the planar inner surface to the planar outer surface, so that the through holes are normal to the planar inner surface and the planar outer surface of the at least one arc-shaped damping pad. Furthermore, the at least one arc-shaped damping pad is formed of an elastomeric material.

In another aspect, a damping assembly for a drive sprocket of a mobile industrial machine includes at least one arc-shaped damping pad, made of an elastomeric material, that includes a radially outer surface and a radially inner surface; a planar inner surface and a planar outer surface. Both the planar inner surface and the planar outer surface of the at least one arc-shaped damping pad extend between the radially outer surface and the radially inner surface. The at least one arc-shaped damping pad also includes a plurality of through holes extending through the at least one arc-shaped pad from the planar inner surface to the planar outer surface, and normal to the planar inner surface and the planar outer surface. The damping assembly includes at least one arc-shaped backing plate with a plurality of through holes that are configured to align with the plurality of through holes of the at least one arc-shaped damping pad. Lastly, the damping assembly includes a plurality of tubular spacers. When in an assembled configuration of the damping assembly, a portion of the spacers is located on one side of the at least one arc-shaped damping pad and the at least one arc-shaped backing plate is located on an opposite side of the at least one arc-shaped damping pad.

In a further aspect, a method of assembling a damping assembly for a drive sprocket of a mobile industrial machine, the damping assembly including an arc-shaped damping pad, an arc-shaped backing plate, and a plurality of spacers. The method includes coupling the arc-shaped damping pad, arc-shaped backing plate, and the plurality of spacers on a first side of drive sprocket so that the arc-shaped damping pad is located between a sprocket gear member of the drive sprocket and arc-shaped backing plate. The arc-shaped pad axially aligns with an edge of the drive sprocket, adjacent to a plurality of teeth of the drive sprocket. The coupling step includes securing fasteners through the arc-shaped damping pad, arc-shaped backing plate, the plurality of spacers, and a plurality of holes in a flange of the drive sprocket.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a side view of a track-type mobile industrial machine including a side-mounted sprocket damping assembly, according to aspects of the disclosure.

FIG. 2 is an enlarged, isometric view of the sprocket damping assembly on the drive sprocket of FIG. 1.

FIG. 3 is a cross-sectional view taken through line 3-3 of FIG. 2 of a portion of the drive sprocket and the sprocket damping assembly.

FIG. 4 is an outer view of an assembled ring of sprocket gear members and the sprocket damping assembly of FIG. 1.

FIG. 5A is an outer view of an individual sprocket gear member and the sprocket damping assembly of FIG. 4.

FIG. 5B is an inner view of the individual sprocket gear member and the sprocket damping assembly of FIG. 4.

FIG. 5C is a radially outward view of the individual sprocket gear member and the sprocket damping assembly of FIG. 3.

FIG. 6A is a view of a backing plate of the sprocket damping assembly of FIGS. 5B-5C.

FIG. 6B is a view of a damping pad of the sprocket damping assembly of FIGS. 5A-5C.

FIG. 6C is an isometric view of an assembly spacer of the sprocket damping assembly of FIG. 5C.

FIG. 7 is a flowchart illustrating a method for assembling the damping assembly onto a track-type mobile industrial machine, according to aspects of the present disclosure.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

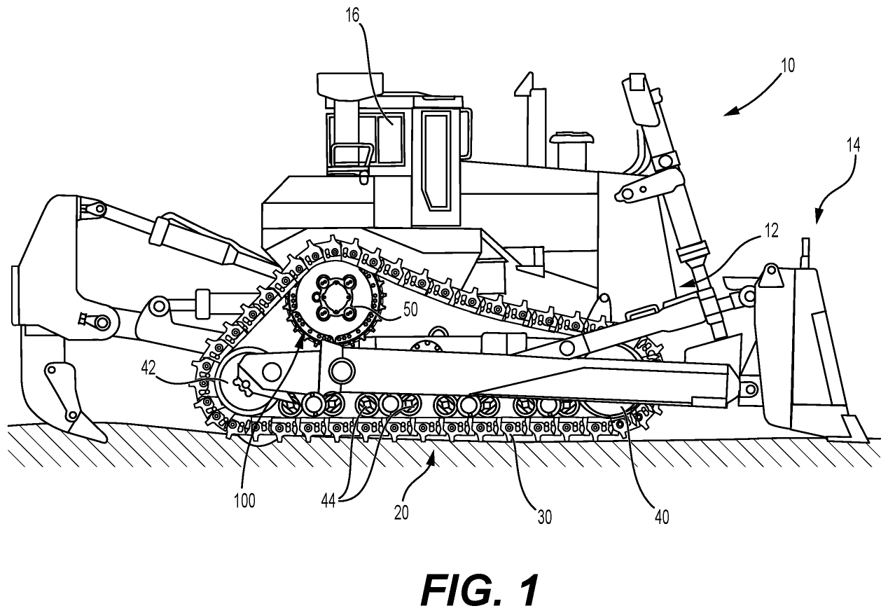

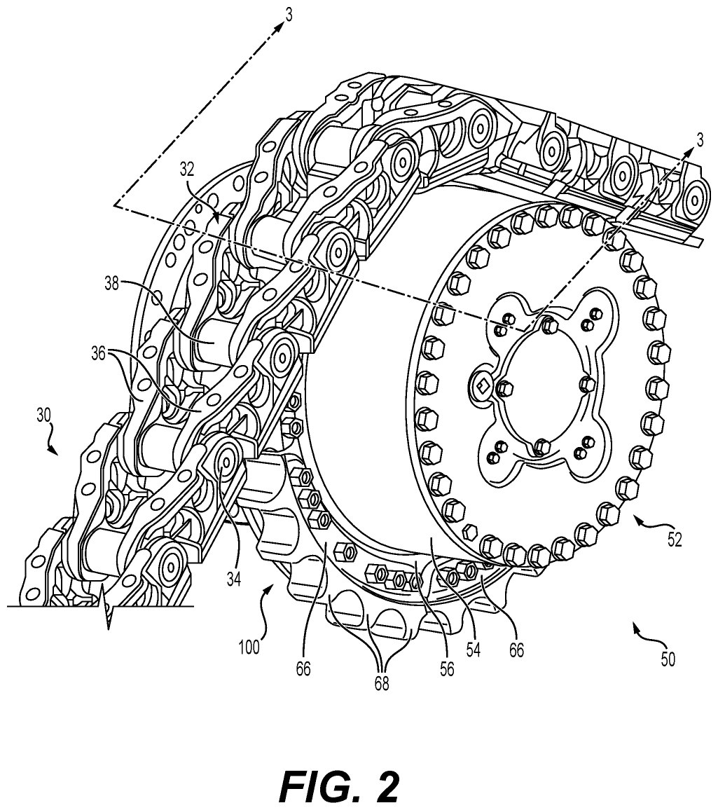

FIGS. 1 and 2 depicts a mobile industrial machine 10 comprising a track drive assembly 20 with a power source (not shown) and a sprocket damping assembly 100. The track drive assembly 20 includes a pair of continuous ground-engaging tracks 30 (one of which is visible in FIG. 1), a plurality of idler wheels and rollers 40-44, and at least one drive sprocket 50. The sprocket damping assembly 100, as shown in FIG. 2, is attached to a side surface of the drive sprocket 50 facing the machine 10, according to aspects of the present disclosure. While the mobile industrial machine 10 of FIG. 1 is shown in the context of a heavy-duty track-type tractor, the sprocket damping assembly 100 of the present disclosure is not thereby limited, and other types of track-type work machines, such as excavators, track loaders, and other similar machines, may include the sprocket damping assembly 100. As shown in FIG. 1, track-type tractor 10 may include a tractor frame 12 mounted to the track drive assembly 20, one or more implement systems 14 attached to a portion of the tractor frame 12, and an operator cabin 16.

The ground-engaging tracks 30 extend around the drive sprocket 50 and the idler wheels and rollers 40-44 of the track drive assembly 20. Note that while only a single drive sprocket 50, a single front idler 40, a single rear idler 42, and multiple idle rollers 44 are shown in FIG. 1, additional drive sprockets 50 and idler wheels 40-44 may be used in the track drive assembly 20 and would have identical structural features. The track drive assembly 20 may also include several different drive configurations. For example, FIG. 1 illustrates a high-drive configuration, where the drive sprocket 50 is positioned vertically higher than a front idler wheel 40 and a rear idler wheel 42; however, alternative configurations, such as a low-drive configuration where the drive sprocket 50 replaces the rear idler wheel 42, are possible.

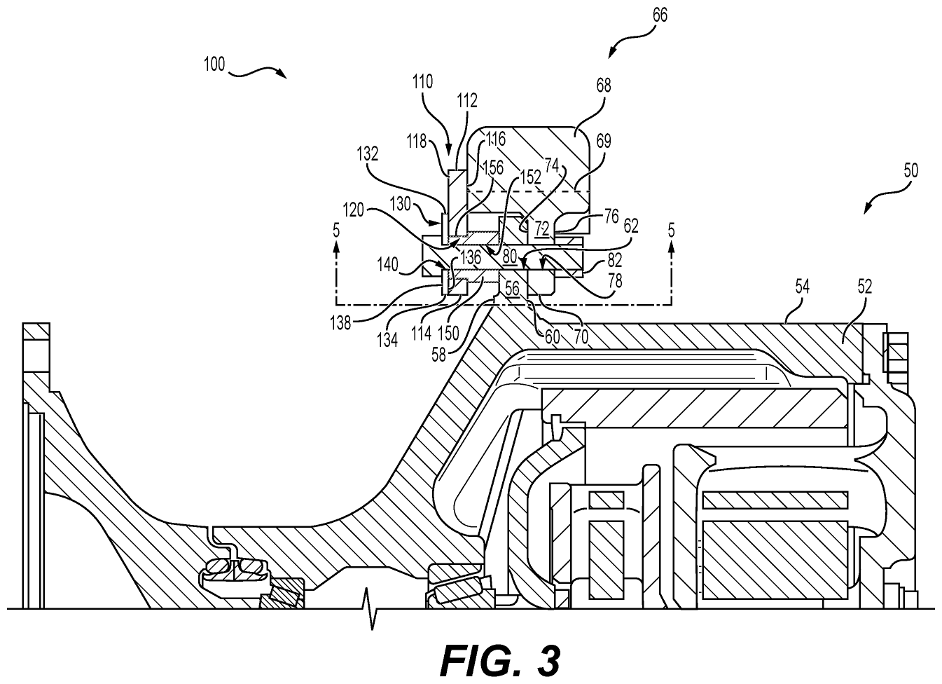

FIG. 2 illustrates the drive sprocket 50 and a portion of the ground-engaging track 30 in further detail. The drive sprocket 50 is a sprocket wheel that includes a sprocket drum 52 with an external circumferential surface 54, and a plurality of sprocket gear members 66. The sprocket gear members 66 are arc shaped with a plurality of sprocket teeth 68. The sprocket gear members 66 are fixedly mounted, e.g., via bolts onto the sprocket drum 52 via a radial flange 56 (located beneath the sprocket gear members 66; shown in FIG. 3) extending radially outward from the external circumferential surface 54, as shown in exemplary FIGS. 2 and 3. While a pair of sprocket gear members 66 are illustrated in FIG. 2, additional sprocket gear members 66 may be utilized to form a circumferential set of sprocket teeth 68. Alternatively, the drive sprocket 50 may be made of a unitary body with integral sprocket teeth 68, or may utilize a single, unitary, circumferential sprocket gear ring rather than multiple sprocket gear members 66.

The ground-engaging track 30, as shown in FIG. 2, includes a plurality of track link assemblies 32 connected via link pins 34. Each of the track link assemblies 32 includes a pair of track links 36 spaced apart by an integral link bushing 38. While individual track components 32-38 of the ground-engaging track 30 are shown in FIG. 2, additional track components 32-38 may be used in the ground-engaging track 30 and would have identical structural features. The spacing between the track links 36 allows sprocket teeth 68 to engage the link bushings 38 between the spaced track links 36 and drive the track link assemblies 32 with the drive sprocket 50.

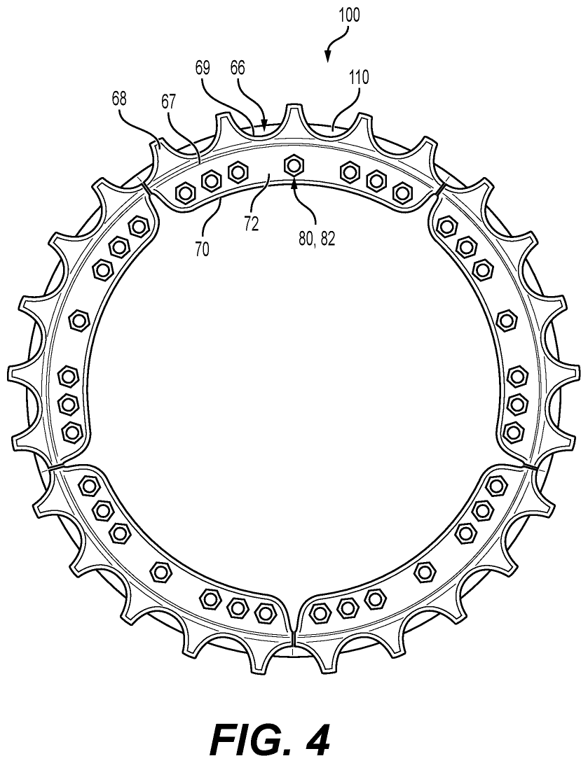

FIG. 3 illustrates a cross-sectional view of a portion of the drive sprocket 50 with the sprocket damping assembly 100 side-mounted to an individual sprocket gear member 66 of the drive sprocket 50. It should be noted that the terms “inner” and “outer” discussed below are used to described structures with respect to the tractor frame 12 of the machine 10. While FIG. 3 depicts a single sprocket damping assembly 100 and a single sprocket gear member 66, additional damping assemblies 100 would be utilized on the drive sprocket 50 so as to circumferentially surround drive sprocket 50, and each would have identical structural features. (See FIG. 4.) Each sprocket gear member 66 includes a mounting flange 72 and the plurality of sprocket teeth 68 (shown in FIGS. 2 and 4). The plurality of sprocket teeth 68 are circumferentially spaced along a radially outer portion 67 (shown in FIG. 4) of the sprocket gear member 66. The mounting flange 72 of the sprocket gear member 66 extends radially inward from the plurality of sprocket teeth 68 and terminates in a radially inner surface 70 of the sprocket gear member 66. The mounting flange 72 includes an axially inner side surface 74 and an axially outer side surface 76 located on either side of the mounting flange 72, and a plurality of through holes 78 spaced radially outward from the radially inner surface 70. The plurality of sprocket gear members 66 are mounted to the radial flange 56 of the drive sprocket 50 along one of the axial side surfaces 74 of the mounting flange 72.

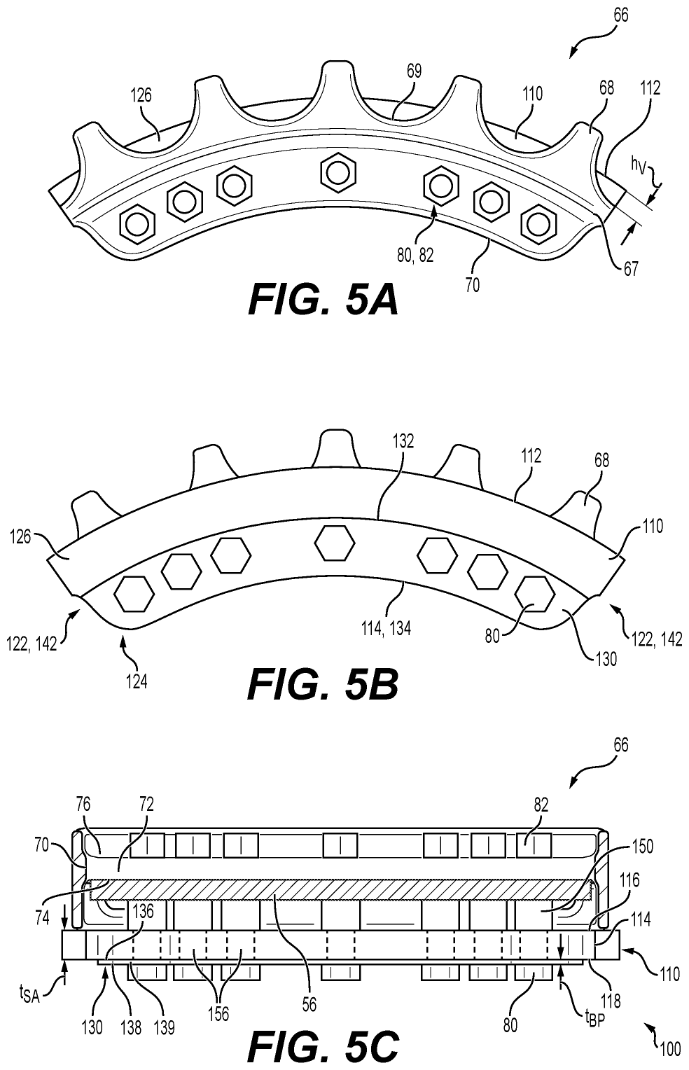

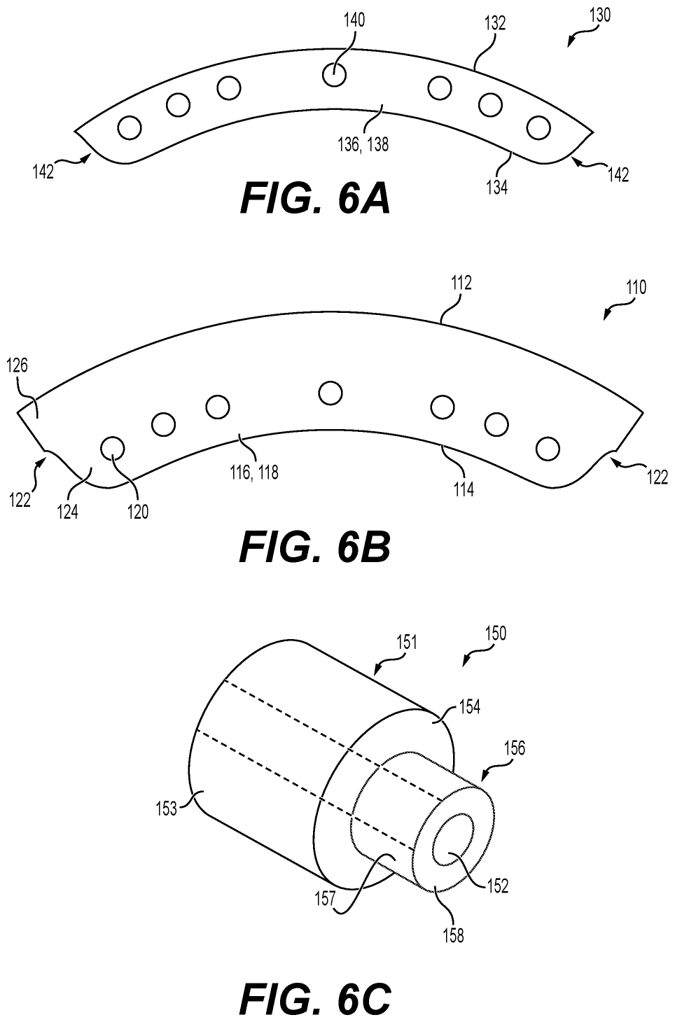

The sprocket damping assembly 100 of FIG. 3 includes a damping pad 110 (individually shown in FIG. 6B), a rigid backing plate 130 (individually shown in FIG. 6A), and a plurality of assembly spacers 150 (individually shown in FIG. 6C). Both the damping pad 110 and the backing plate 130 include a plurality of radial outer surfaces and radially inner surfaces 112, 114 and 132, 134, respectively, and a planar outer surface and a planar inner surface 116, 118 and 136, 138, respectively. Damping pad 110 and backing plate 130 also include a plurality of through holes 120, 140 extending normal through an axial thickness t_{SA} of the damping pad 110 and a thickness t_{BP} of backing plate 130 (see FIGS. 5C, 6A, and 6B). Referring to FIG. 6C, the assembly spacers 150 each include a generally tubular body 151 with a central through hole 152 extending through the entirety of the spacer 150. The through holes 120 of the damping pad 110 may be sized to allow for a portion of the tubular body 151 to extend through the damping pad 110. The spacers 150 may be a full tubular shape, or as shown in FIG. 6C may be a compound cylindrical shape including a stepped retaining feature 156 that is received in through holes 120 of the damping pad 110. The stepped retaining feature may be formed by a step 154 transitioning the spacer 150 to a smaller diameter section 157 extending to an end 158 of the spacer 150. As shown in FIG. 3, the tubular body 151 of the spacers 150 extend between the outer surface 136 of backing plate 130, through damping pad 110, and to the inner side surface 58 of radial flange 56. As noted above, the stepped retaining feature 156 may extend through the damping pad 110 and terminate at the backing plate 130 so that the damping pad 110 aligns with an inner edge of the drive sprocket 50 adjacent the plurality of teeth 68. Thus, the full length of the spacers 150 serve to axially align the damping pad 110 with the edge of the drive sprocket 50 adjacent to the plurality of teeth 68.

As shown in FIG. 3, the mounting flange 72 of the sprocket gear member 66 is mounted to an axially outer side surface 60 of the radial flange 56. On the axially inner side surface 58 of the radial flange 56, the through holes 152, 120,140 of the sprocket damping assembly components 150, 110, and 130 are aligned with the through holes 62,78 of the radial flange 56 and the mounting flange 72, and the sprocket damping assembly components 150, 110, and 130 are mounted to an axially inner side surface 58 of the radial flange 56. As shown in FIG. 3, the radially inner bottom surfaces 114, 134 of the damping pad 110 and the backing plate 130 are spaced away from an external surface of the sprocket drum 52. Stated another way, the radially inner bottom surfaces 114, 134 of the sprocket damping assembly 100 do not contact the drive sprocket 50, resulting in a void of empty space between the sprocket damping assembly 100 and the drive sprocket 50.

The sprocket damping assembly components 110, 130, and 150 are mechanically connected to the radially flange 56 and the mounting flange 72 by a plurality of threaded fasteners 80, 82. In FIG. 3, the plurality of threaded fasteners are a plurality of threaded bolts 80 and threaded nuts 82, although other similar mechanical fasteners may be used. Additionally or alternatively, the sprocket damping assembly 100 may include a plurality of washers (not shown), which may be used either in support of or as a replacement to the backing plate 130 to provide additional rigidity and structural support to the damping pad 110 when coupled to the radial flange 56. As shown, the plurality of fasteners 80, 82 may also used to secure sprocket gear members 66 to the radial flange 56. Furthermore, while FIG. 3 illustrates that the sprocket gear members 66 are side-mounted to an axially outer side face 60 and the damping assemblies 100 side-mounted to an axially inner side face 58 of the radial flange 56, the positions of the sprocket gear members 66 and damping assemblies 100 could, alternatively, be reversed and side-mounted on the opposite sides of the radial flange 56. Furthermore, in an alternative design, the damping assemblies 100 may be attached to a drive sprocket 50 that does not utilize such gear members 66 (not shown).

FIGS. 5A-5C illustrate various views of the sprocket damping assembly 100 mounted to an individual sprocket gear member 66. In particular, FIG. 5A depicts an outer view, FIG. 5B depicts an inner view, and FIG. 5C depicts an under view, respectively, of the sprocket damping assembly 100. The damping pad 110 extends from the radially inner bottom surface 114 to the radially outer top surface 112, located at a height above the radially outer portion 67 of the sprocket gear member 66. This upper portion 126 of the damping pad 110 extends vertically above groove or trough sections 69 between the adjacent sprocket teeth 68 that receive the bushings 38 of the continuous ground-engaging track 30 (shown in FIG. 2). The upper portion 126 of the damping pad 110 includes a variable coverage height h_{V} measured from a groove midpoint or (maximum depth) located between two adjacent sprocket teeth 68 to the radially outer top surface 112 of the damping pad 110. The variable coverage height h_{V} may vary depending on the size of the sprocket gear member 66 and the size of the damping pad 110 used.

The inner view of FIG. 5B depicts the damping pad 110 and the backing plate 130, specifically illustrating the placement of the backing plate 130 and threaded bolts 80 along a lower portion 124 of the damping pad 110. The damping pad 110 and the backing plate 130 both include a pair of matching contoured ends 122, 142 that substantially match the shape of the sprocket gear member 66 (shown in FIGS. 5A and 5C). The contoured edges 122,142 allow for the combined damping pad 110 and the backing plate 130 to be arranged along the radial flange 56 in an aligned and uniform manner (shown in FIGS. 1, 2, and 4).

In the under view of FIG. 5C, the combined sprocket damping assembly 100 and sprocket gear member 66 are shown, with the sprocket damping assembly components 110, 130, 150 and the sprocket gear member 66 having a general alignment. The stepped retaining feature 154 of the spacers 150 extends through the axial thickness of the damping pad (t_{SA}) to contact the backing plate 130. Additionally, FIG. 5C shows the axial thicknesses of the backing plate (t_{BP}) and the damping pad (t_{SA}). In the current example, the axial thickness of the backing plate (t_{BP}) is shown to be less than the axial thickness of the damping pad (t_{SA}).

The individual components 110, 130, 150 of the sprocket damping assembly 100 are shown in FIGS. 6A-6C. The backing plate 130, as shown in FIG. 6A, includes a generally arc or arcuate shape and may be fabricated from a rigid material, such as steel, other metal materials, polymers or other appropriate rigid materials. The damping pad 110, as shown in FIG. 6B, may include a similar arc or arcuate shape along its lower portion 124 with a plurality of through holes 120 which corresponds to the shape and placement of through holes 140 of the backing plate 130. As noted above, the upper portion 126 of the damping pad 110 extends above the radially outer surface 67 of the sprocket gear assembly 66 (shown in FIG. 5A). In particular, the plurality of through holes 120 are located on a radially lower half of the at least one arc-shaped damping pad 110 and positioned to secure the arc-shaped damping pad 110 to the drive sprocket 50 at a location to protrude to a height h_{V} above a maximum depth of the trough section 69 formed between teeth 68 of the drive sprocket 50 (FIG. 5A).

Due to the need for a resilient material that can withstand the extreme forces generated by the ground-engaging track 30 (shown in FIG. 2), the damping pad 110 may be fabricated from an elastomeric or resilient material, such as rubber, polyurethane, other polymers and elastomers, or other similar materials. Thus, damping pad 110 maybe be more flexible than backing plate 130, while the backing plate 130 is stiffer than the damping pad 110.

FIG. 6C generally depicts an individual assembly spacer 150, including the generally tubular body 151 and the stepped retention feature 156 with the central through hole 152 extending through both structures 151, 156. As noted above, the stepped retaining feature 156 includes a smaller diameter section 157 that is spaced radially inwardly from a greater diameter section 153 of the spacer 150. The assembly spacer 150 may be fabricated from rigid materials, such as steel; however, other materials are contemplated, such as alternative metals, thermoplastic polymers, or other appropriate materials.

### INDUSTRIAL APPLICABILITY

The disclosed aspects of the sprocket damping assembly 100 for the drive sprocket 50 of the present disclosure may be used on a track assembly of a track-type mobile machine to reduce the amount of noise generated by the metal-to-metal contact of sprocket teeth 68 coming into contact with bushings 38 of track link assemblies 32 when the tractor-type industrial machine 10 is operating. Specifically, side mounting the sprocket damping assembly 100 to the drive sprocket 50 may assist in reducing the forces experienced by the sprocket teeth 68 and preventing excessive noise generation.

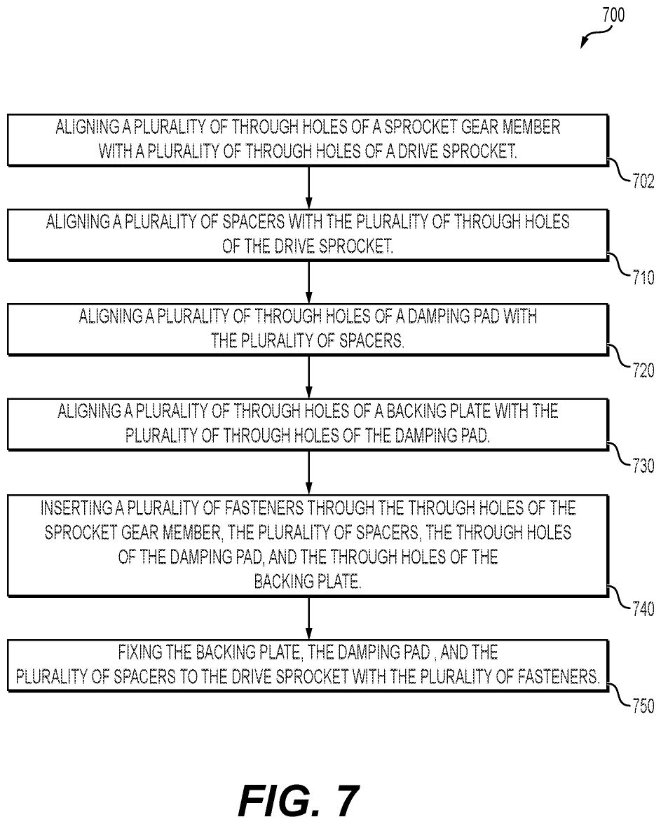

FIG. 7 is a flowchart illustrating an exemplary method 700 for incorporating the damping assembly 100 onto a drive sprocket 50 of the mobile industrial machine 10 according to aspects of the present disclosure. In order to facilitate installation, the sprocket damping assembly 100 may be included in a kit (not shown) that includes the damping pads 110, the backing plates 130, the plurality of spacers 150, and a plurality of fasteners 80, 82. As shown in FIGS. 1 and 2, due to the variable coverage height h_{V} of the damping pad 110 above the midpoint or (maximum depth) of trough section 69, the damping pad 110 contacts the track links 22 prior to the bushings 30 engaging with the sprocket teeth 68. This is achieved by the sprocket damping assembly 100 and a plurality of sprocket gear members 66 being installed onto axial side surfaces 58, 60 of a sprocket drum radial flange 56. The plurality of assembly spacers 150 serves as to axially align the damping pad 110 with the drive sprocket 50, while also acting as a support for the damping pad 110 while the damping pad 110 is being compressed against the backing plate 130 and the radial flange 56. Each of the components of the sprocket damping assembly 100 (i.e., the plurality of assembly spacers 150, the at least one damping pad 110, and the at least one backing plate 130) include at least one through hole 120, 140, 152 respectively, and these through holes 120, 140, 152 are configured to align with a plurality of through holes 78 in the sprocket gear member 66, as shown in FIG. 5C. FIG. 5C specifically illustrates coupling the sprocket damping assembly 100 and the sprocket gear member 66 to the sprocket drum radial flange 56.

Referring back to exemplary FIG. 3, when installing the sprocket damping assembly 100 onto the radial flange 56 of the sprocket drum 52, the through holes 120,140,152 of the sprocket damping assembly 100 align with a plurality of through holes 62 in the radial flange 56 on a first axial side (FIG. 7, steps 710-730) and with the through holes 78 of the sprocket gear member 66 on a second axial side of the radial flange 56 (FIG. 7, 702). To maintain alignment and to secure the sprocket damping assembly 100 in place, a stepped retaining feature 156 of each spacer 150 may be inserted into the individual through holes 120 of the damping pad 110 to contact the backing plate 130. A plurality of threaded bolts 80 are inserted into the sprocket damping assembly component through holes 140 and 152 on the first axial side of the radial flange 56, through the through holes 62 of the radial flange 56, and extend through the through holes 78 of the sprocket gear member 66 (FIG. 7, step 740). The plurality of threaded bolts 80 are attached to a plurality of threaded nuts 82 on the second axial side of the radial flange 56, thereby coupling and securing the sprocket damping assembly 100 and the sprocket gear member 66 to the radial flange 56 (FIG. 7, step 750). The installation of the components 110, 130, 150 of the sprocket damping assembly 100 may be repeated until the radial flange 56 includes a continuous ring of sprocket damping assemblies 100, as shown in exemplary FIGS. 2 and 4. It should be noted, however, that the user may instead choose to strategically space the sprocket damping assembly 100 and sprocket gear members 66 apart from one another in order to develop zones of protection.

While the installation of the sprocket damping assembly 100 is shown to be on an axial outer side face 58 of the drum sprocket radial flange 56 as shown in exemplary FIG. 3, the sprocket damping assembly 100 may be installed on either axial side face 58,60 of the drum sprocket radial flange 56 depending on the configuration of a particular drive sprocket 52 on which the sprocket damping assembly 100 is implemented. For example, in an alternative design, the sprocket damping assembly 100 could be located on an axial outer side face 60 of the sprocket drum radial flange 56 and the sprocket gear member 66 could be located on an axial inner side face 58 of the radial flange 56.

In accordance with the present disclosure, the sprocket damping assembly 100 may reduce the noise generated by the metal-to-metal contact of the sprocket teeth 68 and the ground-engaging track 30 during operation, while fixedly securing the sprocket damping assembly 100 in both the axial and radial directions. Additionally, by securing the damping pads 110 to an axial side face 58 of the radial flange 56, the sprocket damping assembly 100 of the present disclosure helps ensure that the assembly 100 will contact the track 30 and assist in reducing the forces imparted onto the sprocket teeth 68, thereby decreasing the amount of wear and strain on the sprocket teeth and potentially resulting in reduced maintenance costs. Further, the assembly of the sprocket damping assembly with the same fasteners as the sprocket gear member 66 may facilitate installation, maintenance, and cost associated with the drive sprocket 50.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A damping assembly for a drive sprocket of a mobile industrial machine, the damping assembly comprising:
at least one arc-shaped damping pad including:
a radially outer surface;
a radially inner surface;
a planar inner surface extending between the radially outer surface and the radially inner surface;
a planar outer surface extending between the radially outer surface and the radially inner surface; and
a plurality of through holes extending through the at least one arc-shaped damping pad from the planar inner surface to the planar outer surface, and normal to the planar inner surface and the planar outer surface;
wherein the at least one arc-shaped damping pad is formed of an elastomeric material.

2. The damping assembly of claim 1, wherein the plurality of through holes are located to secure the arc-shaped damping pad to the drive sprocket at a location to protrude to a height above a maximum depth of a trough formed between teeth of the drive sprocket.

3. The damping assembly of claim 1, wherein the plurality of through holes are all located on a radially lower half of the at least one arc-shaped damping pad.

4. The damping assembly of claim 3, further including at least one arc-shaped backing plate, the at least one backing plate being formed of a material that is stiffer than the at least one arc-shaped damping pad.

5. The damping assembly of claim 4, wherein the arc-shaped backing plate includes a plurality of through holes that align with the plurality of through holes of the at least one arc-shaped damping pad.

6. The damping assembly of claim 5, further including a plurality of tubular spacers, wherein each of the plurality of spacers include a length to axially align the at least one arc-shaped damping pad with an edge of the drive sprocket adjacent teeth of the drive sprocket.

7. The damping assembly of claim 6, wherein, in an assembled configuration of the damping assembly, a portion of the spacer is located on one side of the at least one arc-shaped damping pad and the arc-shaped backing plate is located on an opposite side of the at least one arc-shaped damping pad.

8. The damping assembly of claim 7, further including a plurality of fasteners connecting the damping assembly to the drive sprocket.

9. The damping assembly of claim 8, wherein the at least one arc-shaped damping pad includes a plurality of arc-shaped damping pads sized to circumferentially surround the drive sprocket.

10. A damping assembly for a drive sprocket of a mobile industrial machine, the damping assembly comprising:
at least one arc-shaped damping pad made of an elastomeric material, the at least one arc-shaped damping pad including:
a radially outer surface and a radially inner surface;
a planar inner surface and a planar outer surface, wherein both the planar inner surface and the planar outer surface extend between the radially outer surface and the radially inner surface of the at least one arc-shaped damping pad; and
a plurality of through holes extending through the at least one arc-shaped pad from the planar inner surface to the planar outer surface, and normal to the planar inner surface and the planar outer surface;
at least one arc-shaped backing plate, the arc-shaped backing plate including a plurality of through holes that align with the plurality of through holes of the at least one arc-shaped damping pad; and
a plurality of tubular spacers,
wherein, in an assembled configuration of the damping assembly, a portion of the spacers is located on one side of the at least one arc-shaped damping pad and the at least one arc-shaped backing plate is located on an opposite side of the at least one arc-shaped damping pad.

11. The damping assembly of claim 10, wherein the plurality of through holes of the at least one arc-shaped damping pad are located to secure the arc-shaped damping pad to the drive sprocket at a location to protrude to a height above a maximum depth of a trough formed between teeth of the drive sprocket.

12. The damping assembly of claim 11, wherein the plurality of through holes of the at least on arc-shaped damping pad are all located on a radially lower half of the at least one arc-shaped damping pad.

13. The damping assembly of claim 12, wherein each of the plurality of spacers include a length to axially align the at least one arc-shaped damping pad with an edge of the drive sprocket adjacent teeth of the drive sprocket.

14. The damping assembly of claim 13, wherein the at least one arc-shaped backing plate is formed of a metal material.

15. The damping assembly of claim 10, wherein the drive sprocket includes an arc-shaped gear member with a plurality of teeth, the arc-shaped gear member including a plurality of through holes configured to attach the arc-shaped gear member with a circumferential flange of the drive sprocket,
wherein the plurality of through holes of the arc-shaped damping pad and the plurality of through holes of the arc-shaped backing plate align with the plurality of through holes of the arc-shaped gear member.

16. The damping assembly of claim 15, wherein, in an assembled configuration of the damping assembly,
the at least one arc-shaped damping pad, the arc-shaped backing plate, and the plurality of spacers are coupled on one side of the drive sprocket, and
the at least one arc-shaped gear member is coupled on an opposite side of the drive sprocket, and secured to the drive sprocket by the same fastening members as the at least one arc-shaped damping pad, the arc-shaped backing plate, and the plurality of spacers.

17. A method of assembling a damping assembly for a drive sprocket of a mobile industrial machine, the damping assembly including an arc-shaped damping pad made of an elastomeric material, an arc-shaped backing plate, and a plurality of spacers, the method comprising:
coupling the arc-shaped damping pad, arc-shaped backing plate, and the plurality of spacers on a first side of drive sprocket so that the arc-shaped damping pad is located between a sprocket gear member of the drive sprocket and arc-shaped backing plate, and the arc-shaped pad axially aligns with an edge of the drive sprocket adjacent to teeth of the drive sprocket,
wherein the coupling includes securing fasteners through the arc-shaped damping pad, arc-shaped backing plate, the plurality of spacers, and a plurality of holes in a flange of the drive sprocket.

18. The method of claim 17, wherein each fastener extends through each of the flange of the drive sprocket, a spacer, an arc-shaped pad, and an arc-shaped backing plate.

19. The method of claim 18, the method further including fastening an arc-shaped gear member having a plurality of teeth to the flange of the drive sprocket during the fastening of the damping assembly.

20. The method of claim 19, wherein the arc-shaped gear member is fastened on a side of the flange opposite the plurality of spacers, arc-shaped damping pad, and arc-shaped backing plate.
